(19) United States
(12) Patent Application Publication
(10) Pub. No.: US 2007/0027924 A1
(43) Pub. Date: Feb. 1, 2007

(54) Systems and methods for providing a product description at a point-of-sale

(76) Inventor: Gregory P. Hopkins, Milton (CA)

Correspondence Address: MCGARRY BAIR PC, 171 MONROE AVENUE, N.W., SUITE 600, GRAND RAPIDS, MI, 49503, US

(21) Appl. No.: 11/491,375

(22) Filed: Jul. 24, 2006

Related U.S. Application Data
(60) Provisional application No. 60/701,998, filed on Jul. 25, 2005.
(60) Provisional application No. 60/701,997, filed on Jul. 25, 2005.

(51) Int. Cl. G06F 17/00

(52) U.S. Cl. 707/104.1

(57) ABSTRACT

A system for providing a product description, for example at a point of sale, has a database storing a product description, a contact means related to the product description within the database, and a transmission means for transmitting the product description. A method of providing a product description, for example to a customer at a point of sale, has steps of displaying a contacting means relating to a product, receiving a communication employing the contacting means, retrieving a product description from a database in response to receiving the communication and transmitting the product description.

This is an application claiming the benefit under 35 USC 119(e) of U.S. Application Ser. Nos. 60/701,998 filed Jul. 25, 2005 and 60/701,997 filed Jul. 25, 2005. Application Ser. Nos. 60/701,998 and 60/701,997 are incorporated herein in their entirety by this reference to them.

### FIELD

This specification relates to marketing of products, and, in particular to systems and methods for marketing products.

### BACKGROUND

The comments in this background section are not an admission that anything discussed in this section is prior art or part of the common general knowledge of persons skilled in the art in any country.

Everyday consumers purchase products based on their knowledge and perceptions of the products in relation to their perceived needs and desires. As an example, consumer products include, without limitation, items such as vehicles, home-appliances, home-electronics, power-tools, prepared foods, clothes, music, toys, books etc. The marketing of consumer products occurs on a number of levels, including without limitation, brand management, product placement, competitive pricing, sales-force training, consumer reports and the like. The marketing also occurs in a number of environments.

In particular, a point-of-sale and display is an interesting marketing environment in that such an environment presents a manufacturer with a number of challenges. Generally, at a point-of-sale, a manufacturer sometimes experiences difficulty in ensuring that potential consumers have the information about product offerings of the manufacturer that the manufacturer wants the potential consumers to have when deciding to make a purchase. Such information may sway potential consumers at a point-of-sale in ways that either benefit or cost the manufacturer a sale.

One option for a manufacturer is to open retail outlets staffed by employees that are trained to be knowledgeable of the product offerings of the manufacturer and actively dissuade potential consumers from buying products provided by another competing manufacturer. This option allows the manufacturer an opportunity to better manage consumer perceptions of the product offerings and may be effective in larger cities and suburbs. However, in smaller locations the demand for a certain category of consumer product may not be high enough to warrant the opening of such a retail location. Moreover, the overhead cost of operating such retail locations may be too much for some manufacturers to bear in order to bring their products to the consumer market.

Another option is to engage third-party resellers, such a department store or a store specializing in one or more categories of consumer products (e.g. home-electronics and home-appliances). Manufacturers that have such arrangements have effectively outsourced their direct sales efforts to another company (i.e. the third-party reseller) and a point-of-sale environment provided by a third-party reseller presents a number of potential pitfalls to individual manufacturers. A first potential pitfall is that a particular manufacturer cannot guarantee that the employees of a third-party reseller are sufficiently knowledgeable about specific product offering, and thus able to adequately describe the features and advantages provided by the product offering to potential consumers. A second potential pitfall is that a first manufacturer may not be aware of incentives provided by a second manufacturer to the third-party reseller that cause the employees of the third-party reseller to more aggressively push the products of the second manufacturer, and possible dissuade potential consumers from the product offerings of the first manufacturer. A third potential pitfall is that the first manufacturer may not be aware of incentives provided by the second manufacturer to potential consumers through the third-party reseller that make the products of the second manufacturer more desirable at the point-of-sale. The two latter scenarios present another hidden pitfall, in that goodwill towards the first manufacturer from consumers may be lost in the market if the third-party reseller is somehow more closely aligned with the second manufacturer

### SUMMARY

The following summary is intended to introduce the reader to this specification but not to define any invention. Inventions may reside in a combination or sub-combinations of the apparatus elements or process steps described below or in other parts of this document. The inventor does not waive or disclaim his rights to any invention or inventions disclosed in this specification merely by not describing such other invention or inventions in the claims.

According to an aspect of one or more embodiments of an invention there is provided a system for providing product descriptions comprising: a database storing a product description; a contacting means related to the product description within the database; and a transmission means for transmitting the product description.

In some embodiments the system further comprises a display for displaying the contacting means. In use a user employs the contacting means displayed to access the product description stored on the database.

In some embodiments, the contacting means includes at least one of a telephone number, a fax number and an email address. In some embodiments, the contacting means and product description are uniquely paired.

In some embodiments, the product description includes at least one of text, pre-recorded audio messages, still-pictures, video, video coupled with audio, each in an electronic format, and/or any combination thereof. In some embodiments, the product description for a particular product is provided in multiple languages, text and character formats.

In some embodiments, the transmission means includes at least one of elements of and/or connections to a public and/or private communication network such a cellular network, a wireless Local Area Network (LAN), the Internet, an intranet, a virtual private network, portions of a Publicly Switched Telephone Network (PSTN), Ethernet connections, Universal Serial Bus Connections (USB), and the like.

In some embodiments, the database further includes a listing of a plurality of contacting means and a listing of corresponding product descriptions related to the plurality of contacting means.

In some embodiments, the display includes at least one of a billboard, a poster, a sticker, a price tag and an engraving on a product offering.

According to an aspect of one or more embodiments of an invention there is provided a method of providing a product description: displaying a contacting means for a product; receiving a communication employing the contacting means; retrieving a product description from a database in response to receiving the communication; and, transmitting the product description.

In some embodiments, the method also includes parsing the communication to determine a language preference; and wherein the product description retrieved and transmitted is in the language preference.

Aspects and features of various inventions will become apparent, to those ordinarily skilled in the art, upon review of the following description of the specific embodiments of one or more inventions.

### BRIEF DESCRIPTION OF THE DRAWINGS

For a better understanding of one or more inventions, and to show more clearly how they may be carried into effect, reference will now be made, by way of example, to the accompanying drawings, which illustrate aspects of embodiments of one or more inventions and in which:

FIG. 1 is an illustration of a system for providing product descriptions to consumers according to an embodiment of an invention;

FIG. 2 is an illustration of a system for providing product description to consumers in a menu form according to an embodiment of an invention; and

FIG. 3 is a flow chart depicting a method for providing product descriptions to consumers according to an aspect of an invention.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors and owners reserve all rights in any invention disclosed in an apparatus or process described below that is not claimed in this document and do not abandon, disclaim or dedicate to the public any such invention by its disclosure in this document.

One or more systems or methods for providing product descriptions directly to potential consumers at a point-of-sale are described below. A point-of-sale is any location in which product offerings are made available for purchase to potential consumers, such as for example, and without limitation, a manufacturer-specific retail location (e.g. The Sony Store™), a third-party reseller retail location (e.g. WALMART™), a tradeshow, on the internet, over the phone, etc.

Generally, in accordance with some aspects of an invention, a system includes a database for storing product descriptions that can be reviewed on a personal communication device. The system also includes at least one type of contacting means for accessing the product descriptions stored in the database, a transmission means for sending product descriptions to a personal communication device, and a display of the contacting means for presentation to potential consumers in any number of environments, including, but not limited to a point-of-sale display. In some embodiments, within the database, a respective contacting means is paired with a particular product offering of a manufacturer so that the system can poll the database for a particular product description based on the contacting means. That is, for example, in some embodiments, each product description in the database may be assigned a unique telephone/fax number and/or email address.

In some embodiments, a product description includes, without limitation, at least one of text, pre-recorded audio messages, still-pictures, video, video coupled with audio, each in an electronic format, and/or any combination thereof. Moreover, any text or audio messages included in a product description can be provided in any language according to the preferences of the potential consumers. In some embodiments the contacting means includes, and without limitation, at least one of a telephone/fax number (e.g. a toll-free telephone/fax number), an email address, a general telephone number in combination with a product identification code, an RFID tag. That is, a contacting means as defined herein is any address type of information or electronic mechanism/system that can be employed to establish a data link between a personal communication device and a storage element storing at least a portion of a product description. In some embodiments, the transmission means includes, without limitation, elements of and/or connections to a public and/or private communication network such a cellular network, a wireless Local Area Network (LAN), the Internet, an intranet, a virtual private network, portions of a Publicly Switched Telephone Network (PSTN), Ethernet connections, Universal Serial Bus Connections (USB), and the like. That is, a transmission means is any electronic mechanism/system that can be employed to transmit product description information to a personal communication device. In some embodiments, the display includes, without limitation, a billboard, a poster, a sticker and/or tag placed on displayed product offerings, an engraving on a product offering etc.

In general, a system according to aspects of an embodiment of an invention includes any suitable combination of devices and connections to other networks and/or systems in addition to any suitable combination of hardware, software and firmware for supporting desired functionality and modes of operation.

In operation a potential consumer, perhaps while browsing at a third-party reseller retail location, uses a personal communication device (e.g. a cellular-phone, a personal digital assistant or laptop computer) to request via the contacting means a particular product description from the database. In response, the database is accessed and a product description is sent to the personal communication device. The potential consumer can then use the feature set provided on the personal communication device to review the product description.

It should be noted that many personal communication devices provide text display features in a variety of languages and that it is an option for a user of such a device to select what language and/or character set text is displayed in. Accordingly, an aspect of an invention is to selectively send back a product description to a potential consumer in relation to the language setting on their personal communications devices. That is, for example, in one embodiment, a first potential consumer, having set their personal communication device to display text in English, would receive product descriptions in English, whilst a second potential consumer, having set their personal communication device to display text in Chinese Characters, would receive products descriptions in Chinese. In such embodiments, the system would receive information about the language settings on a personal communication device.

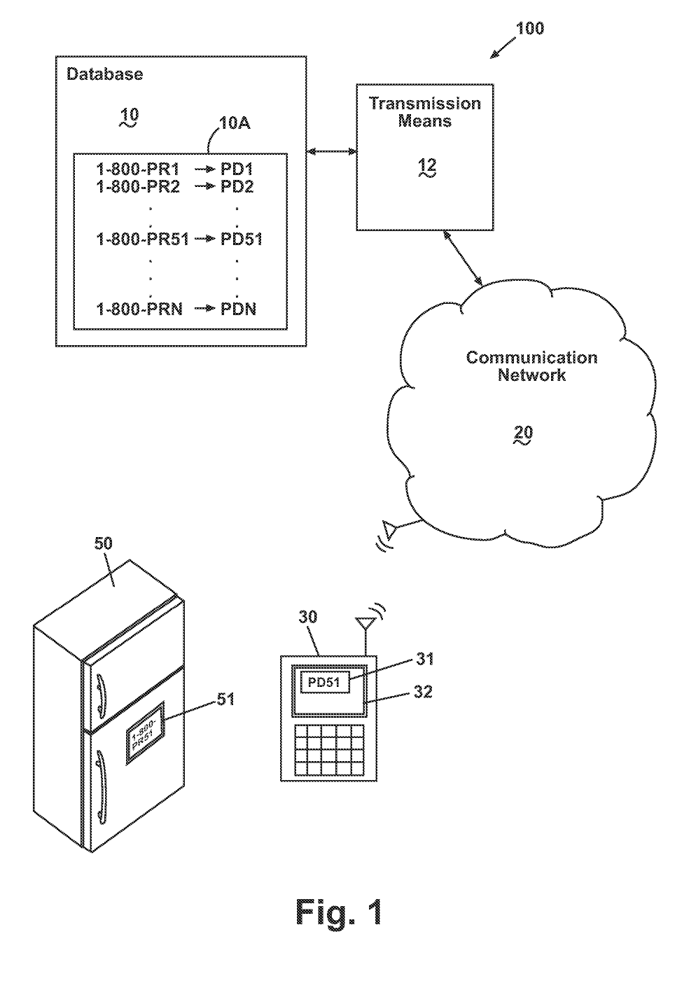

Referring to FIG. 1, shown is a system 100 in accordance with an embodiment of an invention. The system 100 includes a database 10, a transmission means 12, and a display 51. The database 10 includes a portion of a computer readable medium 10a storing thereon a list of contacting means, illustrated for example a list of toll-free telephone numbers (e.g. 1-800-PR51), and a list of corresponding product descriptions (e.g. PD51). That is, each toll-free telephone number is uniquely paired with a corresponding product description within the database 10. The transmission means is connectable to a communication network 20, which as described above includes a suitable combination of hardware, software and firmware and/or connections to various types of elements of a communication network.

The display 51 is located on a refrigerator 50 (or another product), which may in turn be located at a point-of-sale location provided by a third-party reseller. FIG. 1 also includes a simplified drawing of a personal communication device 30 (e.g. a cell. phone) belonging to a potential consumer (not shown).

In operation, while the potential consumer is browsing at a point-of-sale display location, the potential user may come across the refrigerator 50. At this point the potential consumer is able to use the contacting means, which in this case is the toll-free telephone number (1-800-PR51) displayed on the display 51 placed on the refrigerator 50, to poll the database 10. Polling the database 10 is achieving.by dialing the toll-free telephone number (1-800-PR51). The call is placed over the communication network 20 to which the potential consumer subscribes. The call is received from the communication network by the transmission means 12, which in turn receives the corresponding product description (PD51) from the database 10 and transmits the product description (PD51) back to the cellular phone 30. At the cellular phone, the product description is displayed on the monitor 32.

Additionally and/or alternatively, the database 10 and transmission means 12 are managed by a controller (not shown), such as a server or computer that monitors received calls, polls the database 10 and returns the appropriate product descriptions to the transmission means 12 for subsequent transmission.

Additionally and/or alternatively, respective email addresses may also be provided in the database 10, linked to the product descriptions, and provided on displays (e.g. display 51).

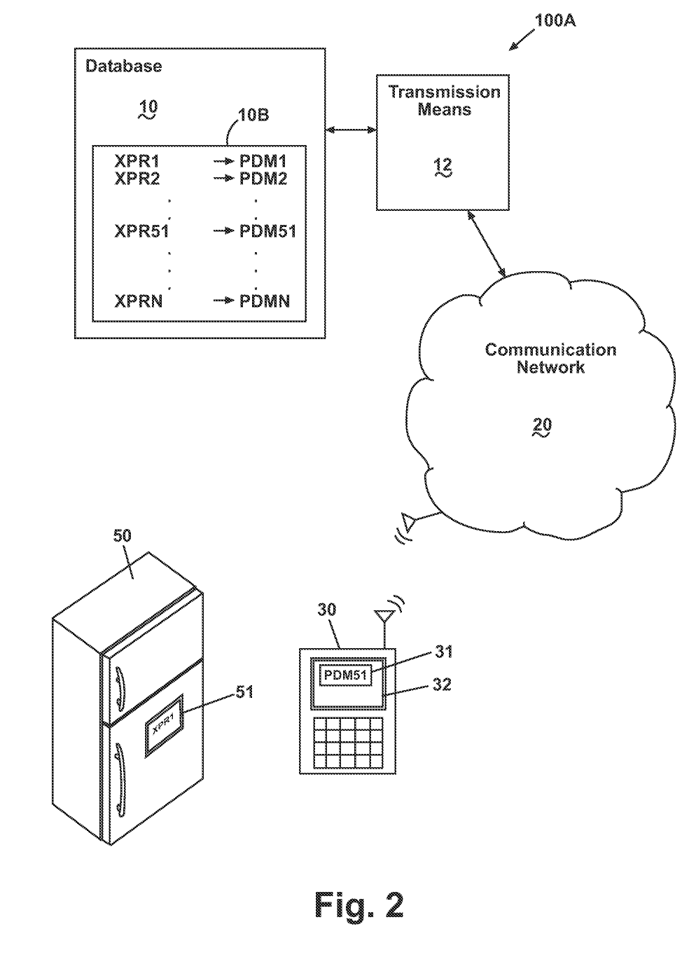

An alternative system 100a for providing product descriptions is illustrated in FIG. 2. The system 100a illustrated in FIG. 2 is similar to the system 100 illustrated in FIG. 1, and accordingly, elements common to both share common reference indicia. The primary difference, illustrated in FIG. 2, is that the database 10 includes a different portion of a computer readable medium 10b storing thereon a list of multiple-digit product identification codes (PICs), illustrated for example a list of PICs (e.g. XPR51 1-800-PR51), and a list of corresponding product description menus (e.g. PDM51). That is, each PIC is uniquely paired with a corresponding product description menu within the database 10. Additionally, the PIC XPR51 is displayed on the display 51 instead of or in addition to a general telephone number, such as a general toll-free telephone number.

In operation, while the potential consumer is browsing at a point-of-sale display location, the potential user may come across the refrigerator 50. At this point the potential consumer is able to use the contacting means, which in this case is a general toll-free telephone number (1-800-GENERAL) displayed on the display 51 placed on the refrigerator 50, to poll the database 10 by further entering in the corresponding PIC XPR51. That is, polling the database 10 is achieving by dialing the general toll-free telephone number (1-800-GENERAL) and then entering the corresponding PIC XPR51 when prompted to do so. The call is placed over the communication network 20 to which the potential consumer subscribes. The call is received from the communication network by the transmission means 12, which in turn receives the corresponding product description menu (PDM51) from the database 10 and transmits the product description menu (PDM51) back to the cellular phone 30. At the cellular phone, the product description menu (PDM51) is displayed on the monitor 32.

The potential consumer can select features from the product description menu (PDM51) to view in more detail. For example, on the cellular phone 30, the potential consumer could press: “1” to receive more information about the construction of the refrigerator 50 (e.g. stress-box construction); “2” to receive more information about the control functions of the refrigerator 50 (e.g. temperature control); “3” to receive more information about the internal features of the refrigerator 50 (e.g. a innovative vegetable tray); and/or “4” to receive more information about the external features of the refrigerator 50 (e.g. an ice-maker). Any and all such information could be provided in a variety and combination of formats (i.e. text, audio, video, etc) and languages as described above. Additionally and/or alternatively, a web-enabled version of the menu system described with respect to the system 100a could also be provided for web-enabled personal communication devices.

Additionally and/or alternatively, the display could be replaced with a Radio Frequency ID (RFID) tag that transmits product description information directly to a personal communication device using an Industrial, Scientific or Medical (ISM) band device, such as for example a blue-tooth enabled modem or infrared modem. Additionally and/or alternatively, such data dumps can be automatic within a vicinity of a point-of-sale display or controlled and requested by the potential consumer as they browse the selections available. In such embodiment, overt displays of a contacting means are not required, as the RFID tag serves as portions of the contacting and transmission means. Additionally and/or alternatively, portions of the database may also be included on the RFID tag.

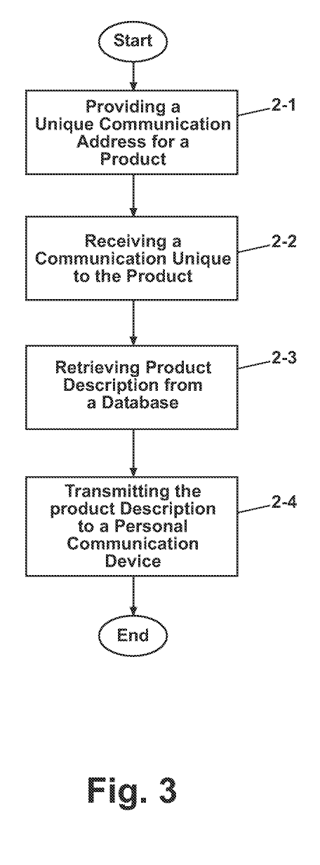

Referring to FIG. 3, shown is a flow chart depicting a method for providing product descriptions to consumers according to an aspect of an invention. Starting at step 2-1, the method includes providing a unique communication address for a product (e.g. a telephone/fax number, email address, etc.) to potential consumers. The step of providing the unique communication address may be, without limitation, the display of the unique communication address on a sticker, price tag, billboard, poster, website, etc.

At step 2-2, the method includes receiving a communication unique to the product. Examples of a communication include a telephone call, an email, a text message, etc. The communication may also include an indication of the language preference of the potential consumer using the service. Additionally and/or alternatively, a unique communication may be made using a combination of a general telephone number and a unique product identification code (PIC) entered by the potential consumer after the general telephone number is employed.

At step 2-3, a database storing product descriptions is polled to retrieve a corresponding product description, which may, in some embodiments, be provided in any number of languages. Subsequently, at step 2-4, the retrieved product description is sent to a personal communication device for the potential consumer to review.

While the above description provides example embodiments, it will be appreciated that the disclosed invention or inventions are susceptible to modification and change without departing from the fair meaning and scope of the accompanying claims. Accordingly, what has been described is merely illustrative of the application of aspects of embodiments of one or more inventions. Numerous modifications and variations of the disclosed inventions are possible in light of the above teachings. It is therefore to be understood that a system or process may be practiced otherwise than as specifically described herein but still be within the scope of a claimed invention.

I claim:

1. A system for providing product descriptions comprising:
a database storing a product description;
a contacting means related to the product description within the database; and
a transmission means for transmitting the product description.

2. A system according to claim 1, further comprising a display for displaying the contacting means, whereby in use a user employs the contacting means displayed to access the product description stored on the database.

3. A system according to claim 1, wherein the contacting means includes at least one of a telephone number, a fax number and an email address.

4. A system according to claim 1, wherein the contacting means and product description are uniquely paired.

5. A system according to claim 1, wherein the contacting means includes a general telephone number and a product identification code.

6. A system according to claim 1, wherein the product description includes at least one of text, pre-recorded audio messages, still-pictures, video, video coupled with audio, each in an electronic format, and/or any combination thereof.

7. A system according to claim 1, wherein the product description for a particular product is provided in multiple languages, text and character formats.

8. A system according to claim 1, wherein the transmission means includes at least one of elements of and/or connections to a public and/or private communication network such a cellular network, a wireless Local Area Network (LAN), the Internet, an intranet, a virtual private network, portions of a Publicly Switched Telephone Network (PSTN), Ethernet connections, Universal Serial Bus Connections (USB), and the like.

9. A system according to claim 1, wherein the database further includes a listing of a plurality of contacting means and a listing of corresponding product descriptions related to the plurality of contacting means.

10. A system according to claim 1, wherein the display includes at least one of a billboard, a poster, a sticker, a price tag and an engraving on a product offering.

11. A method of providing a product description comprising:
receiving a communication employing the contacting means;
retrieving a product description from a database in response to receiving the communication; and
transmitting the product description.

12. A method according to claim 11, further comprising parsing the communication to determine a language preference; and wherein the product description retrieved and transmitted is in the language preference.

13. A method according to claim 11, further comprising displaying a contacting means for a product.

14. A method according to claim 11, wherein the contacting means is one of a telephone/fax number, an email address and a telephone number in combination with a product identification code.
